(19) United States
(12) Patent Application Publication
(10) Pub. No.: US 2017/0132663 A1
(43) Pub. Date: May 11, 2017

(54) APPARATUS AND METHOD FOR PROVIDING MOBILE CONTENT DISPLAY

(71) Applicant: Wal-Mart Stores, Inc., Bentonville, AR (US)

(72) Inventors: Donald R. High, Noel, MO (US); Anton Valkov, San Francisco, CA (US); Brian G. McHale, Chadderton Oldham (GB); Chandrashekar Natarajan, San Ramon, CA (US); Richard T. Wilkinson, Chesapeake, VA (US)

(21) Appl. No.: 15/343,904

(22) Filed: Nov. 4, 2016

Related U.S. Application Data
(60) Provisional application No. 62/251,440, filed on Nov. 5, 2015.

(51) Int. Cl. G06Q 30/02; H04W 4/02

(52) U.S. Cl. CPC G06Q 30/0265; H04W 4/023; G06Q 30/0269

(57) ABSTRACT

Systems, apparatuses and methods are provided herein for providing mobile content display. A system for providing mobile content display comprises a display device on an exterior of a motored vehicle, a communication device, and a control circuit coupled to the display device and the communication device. The control circuit being configured to: authenticate a user device in proximity of the motored vehicle via the communication device, communicatively couple to the user device via a user interface program running on the user device while the motored vehicle is in motion, and cause the display device to display content based on a communication with the user device.

### CROSS-REFERENCE TO RELATED APPLICATION

This application claims the benefit of U.S. Provisional Application Number 62/251,440, filed Nov. 5, 2015, which is incorporated herein by reference in its entirety.

### TECHNICAL FIELD

This invention relates generally to content display.

### BACKGROUND

Commercial trucks spend lengthy amounts of time on the road. Conventionally, exteriors of commercial truck are painted with the truck company's markings and other static graphics.

### BRIEF DESCRIPTION OF THE DRAWINGS

Disclosed herein are embodiments of apparatuses and methods for providing mobile content display. This description includes drawings, wherein:

FIG. 1 is a block diagram of a system in accordance with several embodiments.

FIG. 2 is a flow diagram of a method in accordance with several embodiments.

FIG. 3 is an illustration of a motored vehicle with a mobile display in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for providing mobile content display. A system for providing mobile content display comprises a display device on an exterior of a motored vehicle, a communication device, and a control circuit coupled to the display device and the communication device. The control circuit being configured to: authenticate a user device in proximity of the motored vehicle via the communication device, communicatively couple to the user device via a user interface program running on the user device while the motored vehicle is in motion, and cause the display device to display content based on a communication with the user device.

Interactive mobile billboards may be implemented with vehicles fitted with one or more video displays that alter the displayed content based on where it is located, what it is doing, or where it is headed. The neighborhood, houses, presence of children, the businesses it passes, the activities in which the vehicle is involved in (stopped at a light, etc.), the time of day, or the weather conditions may be taken into consideration in selecting the content to display on the moving billboards. In some embodiments, the displayed content may be different on each side of the vehicle based on the expected audience on that side.

An interactive mobile billboard system may also permit customers to interact with display devices using their smart device with facial recognition and/or with motion tracking technology. Each display on a vehicles may separately interact with different users that have opt-in to the service. The displays may also enable the user to see around the vehicle using cameras placed on the opposite side of the vehicle. For example, users may direct the view of the cameras through their smart device and/or through hand motions.

In some embodiments, trucks, vans, and trailers may be equipped with displays, cameras, and Wi-Fi or Bluetooth transceivers. The vehicle's onboard system may pick up signals or transmissions from users based on one or more of: the user entering a code offered on the side of the truck, detecting a device registered with the mobile display program, and detecting a proximity of users based upon their global positing system (GPS) or Bluetooth strength. In some embodiments, the system may also capture images with the cameras on the vehicle and perform facial recognition to detect registered users. In some embodiments, users may register with the mobile display program through a website and/or a mobile application. When a registered user is detected, the user may sign-in to the display and be given a limited set of actions they can perform to control the displayed content. In some embodiments, each user action may be filtered to ensure only appropriate content is displayed on the display screen. In some embodiments, users may receive targeted advertising on the displays while being able to request the display to perform functions they wish to see. The targeted advertisement may be selected based on the customer's user profile which may include information relating to the customer's shopping patterns, demographics, and preferences. In some embodiments, the displayed content may include one or more of a ball game, a movie, a video clip, and the view around the vehicle. In some embodiments, the system may detect that the user has left the proximate area of the truck and the displayed content may return to a default content such as generic advertising. In some embodiments, a user may also voluntarily sign off the display. In some embodiment, each display may only be assigned to one user at a time but one user may be communicatively coupled to multiple displays. For example, one display device may show the view around the truck while the other may display an advertisement. In some embodiments, the system comprises one or more of a camera, a display device, and a central computer system.

The system disclosed herein may communicatively couple to a smart device, a vehicle mounted display, a central computer, a camera, and/or a communication device to create an interactive session for a pedestrian and/or a driver or passenger in another vehicle. The display may also be configured to automatically display targeted advertising based on profiles of customers in its vicinity.

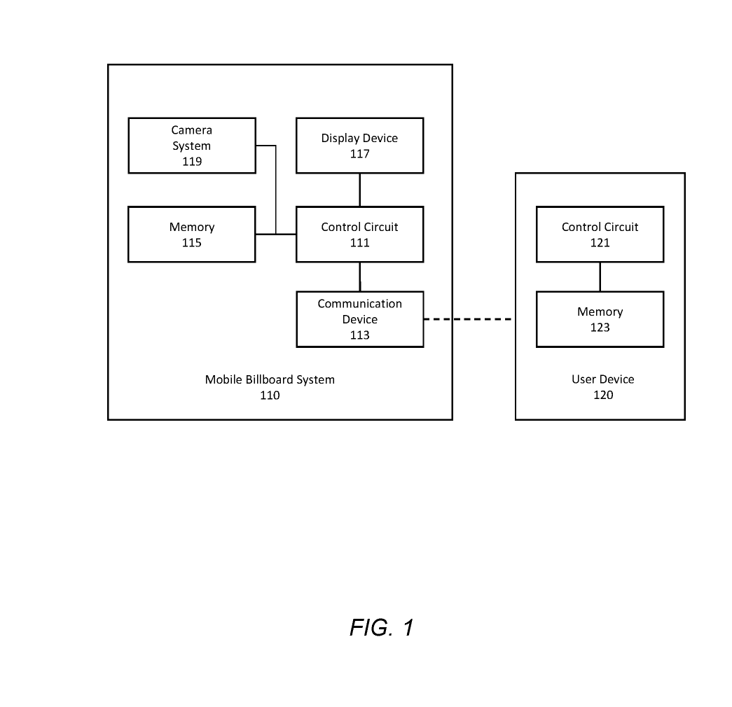

Referring now to FIG. 1, a system for providing mobile content display is shown. The mobile billboard system 110 includes a control circuit 111, a memory 115, a communication device 113, and a display device 117. In some embodiments, the mobile billboard system 110 may further comprise a camera system 119. The mobile billboard system 110 may communicate with a user device 120 via the communication device 113. The user device 120 may include a control circuit 121 and a memory 123.

The mobile billboard system 110 may be a system onboard a motored vehicle such as a truck, a van, a bus, a recreational vehicle (RV), and the like. Generally, the motored vehicle may be any manned or unmanned vehicle powered to travel. In some embodiments, the motored vehicle may be a trailer truck configured to carry cargo in the trailers while having the display device 129 mounted on the outside of the trailers. In some embodiments, the mobile billboard system 110 may be a standalone unit mounted on the vehicle. In some embodiments, the mobile billboard system 110 may be integrated at least partially with the vehicle's control and/or telematics system. Generally, the mobile billboard system 110 may be configured to provide mobile content on the exterior of the vehicle while the vehicle is in motion without active controls from the driver and/or passenger of the vehicle carrying the display screen.

The control circuit 111 may comprise a central processing unit, a processor, a microprocessor, and the like. The control circuit 111 may be configured to execute computer readable instructions stored on a computer readable storage memory 115. The computer readable storage memory 115 may comprise volatile and/or non-volatile memory and have stored upon it a set of computer readable instructions which, when executed by the control circuit 111, causes the system to communicatively couple with the user device 120 and cause the display device 117 to display content based on the communication with the user device 120. In some embodiments, the memory 115 may further store content such as advertisements, videos, graphics, text, etc. that can be displayed on the display device.

The communication device 113 may comprise a short range radio frequency transceiver (e.g. Bluetooth, Wi-Fi) and/or a long range transceiver (e.g. mobile data network transceiver). In some embodiments, communication device 113 may comprise one or more of a wi-fi transceiver, a personal area network transceiver, and a short range data transceiver. The communication device 113 may be configured to scan for the presence of other short range radio frequency signals to detect user devices in its vicinity. In some embodiments, the communication device may be communicatively coupled to the user device 120 to receive data from the user device 120. In some embodiments, the communication between the communication device 113 and the user device 120 may be a direct communication and/or through a remote server. For example, the communication device 113 may broadcast a local wireless network that the user device 120 may access when the user device 120 is within range of the broadcasted signal. In another example, the mobile billboard system 110 and the user device 120 may communicate via a server through a mobile data network and/or the Internet. In some embodiments, the mobile billboard system 110 includes a short range transceiver for communicating with the user device 120 and a longer range transceiver for communicating with a server over a mobile data network (e.g. 3G, 4G, etc.).

The display device 117 may be any device configured to display content to viewers outside of a vehicle. The display device 117 may comprise one or more of a liquid crystal display (LCD), light emitting diode (LED) display, organic light emitting diode (OLED) display, back projection display, and the like. The display device 117 may be mounted on the exterior of the vehicles and/or integrated with an exterior surface (e.g. vehicle wall, panel, etc.) of a vehicle. The vehicle may be any motored vehicle such as a truck, a trailer, a van, a bus, a commercial vehicle, and/or a personal vehicle. In some embodiments, the display device may be positioned on the back and/or a side of the vehicle. In some embodiments, the display device 117 may comprise one or more separately implemented display screens. In some embodiments, a vehicle may carry two or more display devices on one or more exterior surfaces.

In some embodiments, the mobile billboard system 110 may further comprise one or more cameras of a camera system 119 positioned on the opposite side of the vehicle from the display device. The camera(s) may be configured to provide a see-through view of the vehicle. For example, the camera system 119 may be mounted on the front of the vehicle and the display device 117 mounted on the back of the vehicle may display a view in front of the vehicle that is obstructed by the vehicle itself. In some embodiments, the mobile billboard system 110 may further comprise camera(s) facing in the same direction as the display device 117. A user facing camera may be used to perform facial recognition on a viewer(s) of the display device and/or to track user motion and gestures.

In some embodiments, a vehicle may have two more display devices onboard facing in one or more directions. In some embodiments, one or more of the memory 115, the control circuit 111, and the communication device 113 may be coupled to two or more display devices. For example, the control circuit 111 may control the content displayed on multiple display devices or multiple sets of display devices that are assigned to different users. In some embodiments, each display device may have its own mobile billboard system 110, including a control circuit and a communication device.

The user device 120 may generally comprise any processor-based mobile device. In some embodiments, the user device 120 may be one or more of a mobile phone, a smartphone, a tablet device, a mobile computer, a vehicle dashboard system, a wearable device, and the like. The user device 120 may generally be a device carried by a driver or a passenger of another vehicle and/or a pedestrian. The user device 120 includes a control circuit 121 and a memory 123. The control circuit 121 may comprise a central processing unit, a processor, a microprocessor, and the like. The control circuit 121 may be configured to execute computer readable instructions stored on a computer readable storage memory 123. The computer readable storage memory 123 may comprise volatile and/or non-volatile memory and have stored upon it a set of computer readable instructions which, when executed by the control circuit 121, causes the system to communicatively couple with the mobile billboard system 110 and affect the content displayed on the display device 117. In some embodiments, a mobile application (e.g. “App”) may be installed on the memory 123 for the mobile billboard system. The mobile application may allow a user to register with and/or log-in to the mobile billboard service. In some embodiments, the mobile application may cause the user device to automatically couple with the mobile billboard system 110 when a mobile billboard system 110 is within proximity of the user device 120. In some embodiments, the mobile application may notify the user that a mobile billboard system 110 is nearby and accessible. In some embodiments, a user may manually request to couple to the mobile billboard system 110 using the mobile app. In some embodiments, one or more user profiles may be stored on the memory 123. A user profile may store the user's account information, preference, demographic information, shopping history and the like. In some embodiments the mobile application and/or the mobile billboard system may determine what content to display to the user based on the information in the user profile. In some embodiments, once a user device 120 is communicatively coupled to the mobile billboard system 110, the user may manually select content to display on the display device. For example, the user may select from one or more television programs, sports programs, video clips, commercials, musical videos, text messages, etc. to display on the display device 117 using the user device 120. In some embodiments, a list of content may be provided for the user to select. In some embodiments, the user may select any local or web-accessible content (e.g. video streaming services). User selected media may be screened for public display appropriateness prior to being displayed on the mobile billboard system. In some embodiments, the user device 120 may further be used to interact with the content displayed on the display device 117. For example, the user may use the user device 120 to select selectable elements of the displayed content. In some embodiments, the mobile application may permit the user to select a “see through” view for the mobile billboard system 110. The mobile billboard system 110 may provide a view captured by a camera situated on the opposite side of the vehicle such that the user can see around the truck. In some embodiments, the mobile application may include a user interface for controlling the direction and/or focus of the camera. In some embodiments, the functionalities of the mobile application described herein may be provided via a web interface accessible by a web browser. In some embodiments, at least some of the controls described to be provided though the mobile application herein may be detected through motion tracking. For example, a user-facing camera may detect a user's motions as inputs for interactions with the displayed content.

The user device 120 further includes a communication device (not shown) that is configured to communicate with the communication device 113 of the mobile billboard system 110 and/or a mobile network. For example, the user device may include a short range radio frequency transceiver (e.g. Bluetooth, Wi-Fi), a mobile data network transceiver (e.g. 3G, 4G), and the like. In some embodiments, the communication device of the user device 120 may broadcast a signal detectable by the communication device 113 of the mobile billboard system 110 and/or may detect a signal broadcasted by the mobile billboard system. In some embodiments, the communication device of the user device 120 is configured to communicate with a mobile billboard server to detect accessible mobile billboard systems in its surrounding. The user device 120 may also include user input/output devices such as a display screen, a touch screen, one or more keys, a microphone, a speaker, and the like, for interacting with a mobile content user interface displayed on the user device and/or the content displayed on the display device 117 of the mobile billboard system 110. For example, a user may make voice command to the mobile billboard system 110 via a microphone on the user device.

The mobile billboard system 110 and the user device 120 may communicate directly with each other through a local area wireless transmission protocol such as Bluetooth and Wi-Fi, and/or may communicate via a remote server with a mobile data network. For example, data may be transmitted with Bluetooth and/or Wi-Fi protocol between the mobile billboard system 110 and the user device 120 once the devices have authenticated each other and established a local wireless communication channel. In another example, the user device 120 may log onto a remote server and request access of the mobile billboard system. The remote server may authenticate the user device 120 and forward the user device's information and/or content requests to the mobile billboard system 110.

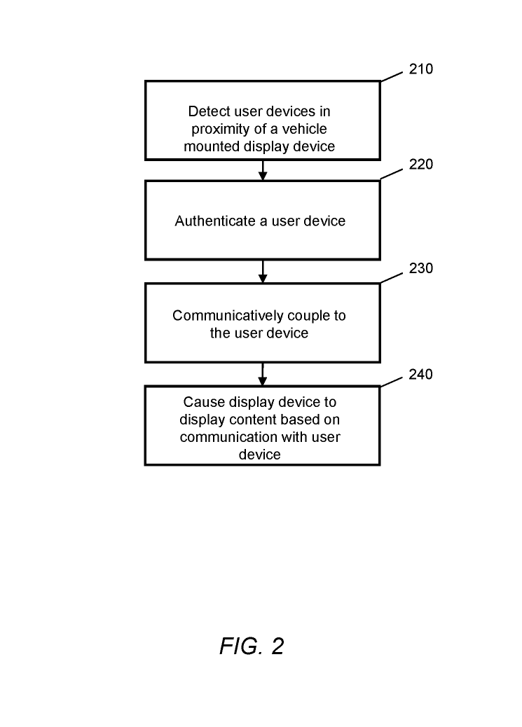

Referring now to FIG. 2, a method for providing mobile content display is shown. Generally, the method shown in FIG. 2 may be implemented with a processor based device such as a control circuit, a central processor, and the like. In some embodiments, the method shown in FIG. 2 may be implemented with the control circuit 111 and/or a processor-based server device communicating with the control circuit 111. Generally, each step shown in FIG. 2 may be performed by one or more of a central server, a mobile billboard system onboard a motored vehicle, and/or a mobile application running on a user device.

In step 210, the system detects one or more user devices in proximity of a display device on an exterior of a motored vehicle. In some embodiments, in step 210, the system scans for signals broadcasted by user devices using a short range transceiver (e.g. Bluetooth, Wi-Fi, etc.) to detect user devices that are nearby. In some embodiments, in step 210, a server provides the mobile billboard system with a list of user device(s) having a global positioning system (GPS) coordinate in proximity of the display device system. In some embodiments, a user device may send a request to the system to access the display device. For example, the user may enter, scan, and/or capture an identifier on the vehicle and/or the display device into the user interface to request access to the identified display device. In another example, the user device may send a connection request via a short range transceiver (e.g. Wi-Fi, Bluetooth etc.) to establish a communication channel. Generally, the detected user device may be a portable device carried in another vehicle and/or with a pedestrian.

In step 220, the system authenticates a user device. The user device may be selected form the one or more user devices detected in step 210. In some embodiments, the user device may be selected from the detected devices based on a first-come-first-served basis as long as the user device is within a predetermined distance threshold from the display device and/or vehicle carrying the display device. The distance between the user device and the display device may be determined based on one or more of the strength of the user device's wireless signal and the user device's GPS coordinate. In some embodiments, the user device may be selected based on its position relative to the display device. For example, the mobile billboard system may determine whether the user device is located in a position that faces the display device (e.g. behind the truck for a display on the back surface of the vehicle) based on the user device's GPS data prior to authenticating with the user device. In some embodiments, the system may determine the user device's direction of travel and deprioritize vehicles traveling in different directions. In some embodiments, if multiple users are detected in step 210, user devices may be prioritized based on their proximity, relative position, and/or direction of travel. For example, a user device that is directly adjacent to the display device may be selected over a user device that is two vehicles away. In some embodiments, in step 220, the system determines whether the user device has registered (opted-in) to participate in the mobile content program. Registration may be based on one or more of: whether the user has installed a mobile content application on the user device, whether the user is logged-in on a user account, whether the user device is storing a user profile for mobile content, whether the user's device ID is registered with the service, whether the user's appearance matches a registered user through facial recognition, etc. In some embodiments, the mobile billboard system onboard the vehicle may communicate with a central server to authenticate the user device. In some embodiments, the user system may communicate with a central server to obtain authentication and forward the authentication certificate to the on-board system via a local wireless connection. In some embodiments, step 220 comprises a local area wireless network protocol authentication In some embodiments, the system only authenticates a user device if the user device is both in proximity of the display device and has registered for the mobile content program.

In step 230, the system communicatively couples to the user device authenticated in step 220. Generally, when a mobile billboard system is communicatively coupled to a user device, the information received from the user device is used to determine the displayed content. The communication between the system and the user device may be via a user interface program running on the user device. The communication may comprise information stored on the user device and/or user inputs in the user interface program. In some embodiments, the user interface program may be an installed mobile application and/or a web browser accessing a web-based user interface. In some embodiments, the mobile billboard system and the user device may be communicatively coupled via a short range transceiver (e.g. Bluetooth, Wi-Fi, etc.). For example, after step 220, the mobile billboard system may allow the user device to access a Wi-Fi network broadcasted by the system. The broadcasted network may be a local area network and/or may be connected to the Internet. In some embodiments, the mobile billboard system may be configured to only communicatively couple to one user device per display device. For example, each display device may become assigned to a user device after steps 220 and 230, and the content display on the display device is determined only based on the assigned user device until the user device is decoupled from the display system.

In step 240, the system causes the display device on the motored vehicle to display content based on a communication from the user device. In some embodiments, once a user device is coupled to the system, the user may manually select content to display on the display device. For example, the user may select from one or more television programs, sports programs, video clips, commercials, musical videos, text messages, etc. to display on the display device 117. The content may be stored on the display system onboard the vehicle, transmitted from the user device, retrieved from a mobile content server, and/or retrieved from a third party content provider (e.g. website, web video streaming service, etc.). In some embodiments, a list of content may be provided for the user to select. For example, the mobile content provider may provide a list of preselected images, video clips, etc. via a user interface on the user device for the user to select from. In some embodiments, the user may select local or web-accessible content (e.g. video streaming services) to display on the display device. User selected content may be screened for public display appropriateness prior to being displayed on the mobile billboard system. The screening may be performed at the system onboard the vehicle and/or at a remote server. In some embodiments, the mobile application may permit the user to select a “see through” view for the mobile billboard system. The mobile billboard system may provide a view captured by a camera situated on the opposite side of the vehicle such that the user can see around the truck. In some embodiments, the mobile application may include a user interface for controlling the direction and/or focus of the camera. In some embodiments, the functionalities of the mobile application described herein may be provided via a web interface accessible by a web browser.

In some embodiments, the displayed content may include an audio component. The display device and/or the user interface on the user device may instruct the user to tune to a radio station to receive radio content. In some embodiments, audio content may be transmitted to and played by the user device.

In some embodiments, the system may determine the content to display on the display device based on a user profile associated the user device authenticated in step 230. A user profile may store the user's account information, preferences, demographic information, purchase history and the like. The user profile may be retrieved from the user device and/or a central server using a user device identifier. The display device may select content that may be of interest to the user based on the user profile. In some embodiments, the system may use the user profile to select targeted advertisement content to display to the user. For example, if the user's purchase history and/or preference indicates that she is particularly interested in non-fiction books, the system may select a non-fiction publication advertisement to display to the user. In some embodiments, the system may resume content that was previously displayed to the user of the user device either on the same mobile display system or on a different display system. For example, the user device and/or a server may store a history of content viewed by the user associated with the user device. The display device may then determine whether the user previously viewed a content item, and continue to display the same content when it becomes communicatively coupled to the user device. In some embodiments, the system may cause two or more type of content to be displayed. For example, a portion of a display screen may display a view on the opposite side of the vehicle while another portion of the display screen may display advertisement content.

In some embodiments, during step 240, the user may further interact with the displayed content. For example, the displayed content may include one or more selectable elements that are linked to acts and/or other content. In some embodiments, the user interface program on the user device may be used to interact with the displayed content. In some embodiments, the mobile billboard system may include cameras for tracking user's motions and the user may use motions and gestures to interact with the displayed content. In some embodiments, the user may provide voice commands to the mobile billboard system via a microphone on the user device.

In some embodiments, one or more of steps 210 and 240 may be performed while one or both of the vehicle carrying the display device and the vehicle carrying the user device are in motion. For example, the user device may be in a vehicle following the vehicle carrying the display device on a highway. In some embodiments, the mobile billboard system may impose a speed restriction (e.g. less than 5 mph) and only allow certain user interactions when the vehicles are in heavy traffic.

In some embodiments, after step 240, the system further determines when to decouple from the user device. In some embodiments, the system may continuously track the user device's location relative to the display device. If the user device leaves the proximate area of the display device (e.g. more than 20 meters away), the system may decouple from the user device and cease to display content based on the communication with the user device. In some embodiments, the system measures the strength of the short range communication connection with the user. If the signal strength becomes too weak (e.g. lower than 2 bars), the system may decouple from the user device. In some embodiments, the system may allow for a buffer time and only decouple from the user device of the distance exceeds the threshold and/or the signal strength falls below the threshold for an extended period of time (e.g. 30 seconds). In some embodiments, the user may manually decouple from the display device via the user interface displayed on the user device.

When a mobile billboard system decouples from a user device, the process may return to step 210 and the mobile billboard system may authenticate and be communicatively coupled to another user device. In some embodiments, prior to step 240 and/or while a display device is not communicatively coupled to a user device, the display device may display default content such as a generic advertisement and/or instructions for participating in the mobile billboard program.

In some embodiments, a vehicle may carry two or more display devices facing different directions. One or more control circuits may carry out steps 210-240 separately for each display device. For example, a display device on the right side of the vehicle may communicatively couple to and display content for a first user device in a first vehicle while a display on the back of the vehicle may communicatively couple to and display content for a second user device in a second vehicle.

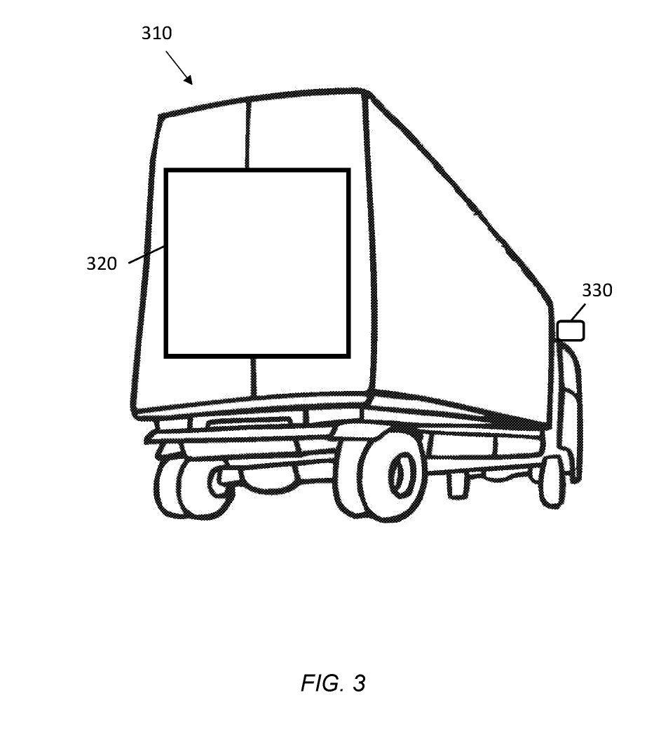

Next referring to FIG. 3, an illustration of a motored vehicle with a mobile display is shown. A truck 310 includes a display device 320 on the back end and a camera system 330 amounted on the front end. In some embodiments, the display device 320 may comprise the display device 117 shown in FIG. 1. Other components of the mobile billboard system 110 described with reference to FIG. 1 may also be carried by the truck 310. For example, the display device 320 may be controlled by a control circuit coupled to a communication device mounted inside the truck 310 behind the display device 320. The camera system 330 is mounted on the opposite of the truck 310 from the display device and may comprise one or more cameras. The mobile billboard system may be configured to use the images captured by the camera system 330 to generate a see-through view on the display device 320 such that drivers behind the truck 310 can partially see the road in front of them, simulating the effect that the truck is transparent.

While the display device 320 is shown to be positioned on the back exterior of the truck 310, display device(s) may be additionally and/or alternatively positioned on one or more sides of the trucks 310. A camera system may also be additionally and/or alternatively positioned on the side(s) of the truck opposite from the display device(s). In some embodiments, the display device 320 may be of any shape or size that fits on the exterior surface of the vehicle. While a semi-trailer truck is shown in FIG. 3, the vehicle carrying the display device 320 may generally be any type of motored vehicle without departing from the spirit of the present disclosure.

In one embodiment, a system for providing mobile content display comprises a display device on an exterior of a motored vehicle, a communication device, and a control circuit coupled to the display device and the communication device. The control circuit being configured to: authenticate a user device in a proximity of the motored vehicle via the communication device, communicatively couple to the user device via a user interface program running on the user device while the motored vehicle is in motion, and cause the display device to display content based on a communication with the user device.

In one embodiment, a method for providing mobile content display comprises: detecting, with a control circuit, one or more user devices in proximity of a display device on an exterior of a motored vehicle; authenticating an user device via a communication device; communicatively coupling to the user device via a user interface program running on the user device while the motored vehicle is in motion; and causing the display device to display content based on a communication with the user device.

In one embodiment, an apparatus for providing mobile content display, comprises a non-transitory storage medium storing a set of computer readable instructions, and a control circuit configured to execute the set of computer readable instructions which causes to the control circuit to: detect one or more user devices in proximity of a display device on an exterior of a motored vehicle; authenticate an user device via a communication device; communicatively couple the control circuit with the user device via a user interface program running on the user device while the motored vehicle is in motion; and cause the display device to display content based on a communication with the user device.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing mobile content display, comprising:
a display device on an exterior of a motored vehicle;
a communication device; and
a control circuit coupled to the display device and the communication device, the control circuit being configured to:
authenticate a user device in proximity of the motored vehicle via the communication device;
communicatively couple to the user device via a user interface program running on the user device while the motored vehicle is in motion; and
cause the display device to display content based on a communication with the user device.

2. The system of claim 1, wherein the motored vehicle comprises a truck and the display device is mounted on the back side of the truck.

3. The system of claim 1, further comprising:
a camera system positioned on a side of the motored vehicle opposite from the display device and facing away from the motored vehicle;
wherein the control circuit is further configured to cause the display device to display images from the camera system.

4. The system of claim 3, wherein the control circuit is configured to modify a direction of the camera system based on user input received via the user interface program.

5. The system of claim 1, wherein the communication device comprises one or more of a wi-fi transceiver, a personal area network transceiver, and a short range data transceiver.

6. The system of claim 1, wherein the control circuit is further configured to: determine whether the user device is adjacent to a side of the motored vehicle having the display device based on a Global Positioning System (GPS) data of the user device.

7. The system of claim 1, wherein the control circuit is configured to select the user device from a plurality of user devices in proximity of the motored vehicle based on locations of each of the plurality of user devices.

8. The system of claim 1, wherein the content corresponds to a media selected by a user on the user device.

9. The system of claim 8, wherein the control circuit is configured to: determine an appropriateness of the media prior to causing the media to be displayed on the display device.

10. The system of claim 1, wherein the content is selected based on a user profile associated with the user device.

11. A method for providing mobile content display, comprising:
detecting, with a control circuit, one or more user devices in proximity of a display device on an exterior of a motored vehicle;
authenticating an user device via a communication device;
communicatively coupling to the user device via a user interface program running on the user device while the motored vehicle is in motion; and
causing the display device to display content based on a communication with the user device.

12. The method of claim 11, wherein the motored vehicle comprises a truck and the display device is mounted on the back side of the truck.

13. The method of claim 11, further comprising causing the display device to display images from a camera system positioned on a side of the motored vehicle opposite from the display device.

14. The method of claim 13, further comprising modifying a direction of the camera system based on user input received via the user interface program.

15. The method of claim 11, wherein the communication device comprises one or more of a wi-fi transceiver, a personal area network transceiver, and a short range data transceiver.

16. The method of claim 11, further comprising: determining whether the user device is adjacent to a side of the motored vehicle having the display device based on a Global Positioning System (GPS) data of the user device.

17. The method of claim 11, further comprising: selecting the user device from the one or more user devices in proximity of the motored vehicle based on locations of each of the one or more user devices.

18. The method of claim 11, wherein the content corresponds to a media selected by a user on the user device.

19. The method of claim 18, further comprising: determining an appropriateness of the media selected by the user prior to displaying the media on the display device.

20. The method of claim 11, wherein the content is selected based on a user profile associated with the user device.

21. An apparatus for providing mobile content display, comprising:
a non-transitory storage medium storing a set of computer readable instructions; and
a control circuit configured to execute the set of computer readable instructions which causes to the control circuit to:
detect one or more user devices in proximity of a display device on an exterior of a motored vehicle;
authenticate an user device via a communication device;
communicatively couple the control circuit with the user device via a user interface program running on the user device while the motored vehicle is in motion; and
cause the display device to display content based on a communication with the user device.
